(19) United States
(12) Patent Application Publication
(10) Pub. No.: US 2026/0266967 A1
(43) Pub. Date: Sep. 10, 2026

(54) METHOD, AND LIDAR FOR SUPPRESSING OPTICAL CROSSTALK IN MULTI-CHANNEL LIDAR

(71) Applicant: AUTOX TECH PTE. LTD., SINGAPORE (SG)

(72) Inventors: Zhuo Li, Shenzhen (CN); Yizhou Shan, Shenzhen (CN); Youqi Jiang, Shenzhen (CN); Kai Ning, Shenzhen (CN)

(73) Assignee: AUTOX TECH PTE. LTD., SINGAPORE (SG)

(21) Appl. No.: 19/213,104

(22) Filed: May 20, 2025

(30) Foreign Application Priority Data
Mar. 7, 2025 (CN) 2025102761081

(51) Int. Cl. G01S 7/484; G01S 7/481

(52) U.S. Cl. CPC G01S 7/484; G01S 7/4815

(57) ABSTRACT

The disclosure provides a method for suppressing optical crosstalk in a multi-channel LiDAR, including steps of: capturing a laser spot pattern projected on a receiving plate by optical beams from emitting channels of the multi-channel LiDAR; wherein the laser spot pattern determines concurrently active emitting channels through an overlap degree, generating a predetermined detection pattern, wherein the overlap degree represents non-interfering regions among multiple laser spot patterns, excluding receiving channels aligned with currently active emitters; dividing a plurality of emitting channels of the multi-channel LiDAR into a plurality of emitting channel groups based on at least one predetermined detection pattern; and sequentially controlling each emitting channel group to emit optical beams according to a predetermined triggering sequence.

### CROSS REFERENCE TO RELATED APPLICATION

This non-provisional patent application claims priority under 35 U. S. C. § 119 from Chinese Patent Application No. 202510276108.1 filed on Mar. 07, 2025 the entire content of which is incorporated herein by reference.

### TECHNICAL FIELD

The disclosure relates to the field of multi-channel LiDARs, and in particular to a method, device, and LiDAR for suppressing optical crosstalk in a multi-channel LiDAR.

### BACKGROUND

A multi-channel LiDAR includes a receiving plate and a plurality of emitting plates, the receiving plate being distributed with a plurality of receiving channels, and each emitting plate being distributed with a plurality of emitting channels. When the receiving plate receives an echo of a light spot reflected by a target object, optical crosstalk may occur due to the overlap of the light spots. Optical crosstalk refers to the phenomenon that when the target object is a high-reflectivity object, the size of the light spot on the receiving plate expands, causing the optical signal to overflow to other receiving channels.

In the prior art, when a multi-channel LiDAR emits light to a target object, the emitting channels on the emitting plate are generally all turned on. When all emitting channels are turned on, the light spots may be densely distributed, leading to the problem of optical crosstalk.

### SUMMARY

The disclosure provides a method, device, and LiDAR for suppressing optical crosstalk in a multi-channel LiDAR to solve the problem of optical crosstalk.

In a first aspect, the disclosure provides a method for suppressing optical crosstalk in a multi-channel LiDAR, the method includes steps of: capturing a laser spot pattern projected on the receiving plate by optical beams from emitting channels; wherein the laser spot pattern determines concurrently active emitting channels through inter-pattern overlap analysis, generating a predetermined detection pattern, the overlap degree represents non-interfering regions among multiple laser spot patterns, excluding receiving channels aligned with currently active emitters; dividing a plurality of emitting channels into a plurality of emitting channel groups based on at least one predetermined detection pattern; and sequentially controlling each emitting channel group to emit optical beams according to a predetermined triggering sequence.

In a second aspect, the disclosure further provides a LiDAR, the LiDAR includes a memory and a processor, the memory being configured to store control program instructions for suppressing optical crosstalk in a multi-channel LiDAR, and the processor being configured to execute the control instructions of the multi-channel LiDAR to implement the above method for suppressing optical crosstalk in a multi-channel LiDAR..

As described above, the method can directly avoid the generation of optical crosstalk by dividing multiple channels into multiple groups of channels according to a predetermined rule for channel light emission, and the groups of channels do not interfere with each other, without the need to generate crosstalk and then eliminate the phenomenon of optical crosstalk through post-processing.

### BRIEF DESCRIPTION OF THE DRAWINGS

FIG. 1 is a flowchart of a method for suppressing optical crosstalk in a multi-channel LiDAR in accordance with an embodiment.

FIG. 2 is a schematic diagram of a laser spot pattern of a multi-channel LiDAR in accordance with an embodiment.

FIG. 3 is a schematic diagram of a local predetermined detection pattern of a multi-channel LiDAR provided by a first embodiment of the disclosure.

FIG. 4 is a schematic diagram of emitting channel grouping of a multi-channel LiDAR provided by a first embodiment of the disclosure.

FIG. 5 is a schematic diagram of emitting channel grouping of a multi-channel LiDAR provided by a second embodiment of the disclosure.

FIG. 6 is a schematic diagram of modules of a device for suppressing optical crosstalk in a multi-channel LiDAR in accordance with an embodiment.

FIG. 7 is a schematic diagram of the structure of a multi-channel LiDAR in accordance with an embodiment.

### DETAILED DESCRIPTION OF THE EMBODIMENTS

In order to make the purpose, technical solution, and advantages of this application clearer and clearer, the following will provide further detailed explanations of this application in conjunction with the accompanying drawings and embodiments. It should be understood that the specific embodiments described here are only intended to explain the disclosure and are not intended to limit the disclosure. Based on the embodiments in this application, all other embodiments obtained by ordinary technical personnel in this field without creative labor fall within the scope of protection of this application.

The terms “first,” “second,” “third,” “fourth,” etc. (if present) in the specification, claims, and accompanying drawings of the disclosure are used to distinguish similar planning objects and are not necessarily used to describe a specific sequence or order. It should be understood that such terms, when used, may be interchangeable under appropriate circumstances. In other words, the described embodiments may be implemented in an order other than that illustrated or described herein. Furthermore, the terms “include” and “have” and any variations thereof may also encompass additional content. For example, a process, method, system, product, or device comprising a series of steps or units is not limited to only those steps or units clearly listed but may include other steps or units not clearly listed or inherent to those processes, methods, products, or device.

It is important to note that the descriptions involving “first,” “second,” etc., in the disclosure are solely for descriptive purposes and should not be understood as indicating or implying their relative importance or implicitly specifying the number of indicated technical features. Therefore, features qualified by “first,” “second,” etc., may explicitly or implicitly include one or more of such features. In addition, the technical solutions among the various embodiments may be combined with each other, but this must be based on the ability of ordinary skilled artisans in the field to achieve such combinations. When the combination of technical solutions contradicts each other or cannot be implemented, such combinations should be deemed non-existent and not within the scope of protection claimed in the disclosure.

A multi-channel LiDAR includes an emitting plate and a receiving plate. The emitting plate is arranged with a plurality of emitters, each emitter includes a corresponding emitting channel. The receiving plate is arranged with a plurality of receivers, each receiver includes a corresponding receiving channel. According to the beam angle formed by the emitting channel emitting the beam and the model of the receiver, multiple receivers are correspondingly arranged on the receiving plate. The emitting channel is configured to emit optical beams, and the receiving channel is configured to receive the beam corresponding to the emitting channel. Multiple emitting channels emit multiple emitting beams, and the emitting beams propagate through the air to the target object, and the target object reflects the multiple emitting beams back to the corresponding receiving channels in the receiving plate to acquire information about the target object.

The emitting channel in the emitter is configured to emit laser pulses (beams) according to a predetermined time sequence and is configured to emit beams into the field of view space to detect three-dimensional information of a target object in the field of view space. A portion of the beams is reflected back by the target object to form a beam echo.

The receiving channel in the receiver is configured to sense photons from the field of view range and output corresponding optical sensing signals. It should be understood that the optical signal sensed by the receiver may include photons (return optical beams) reflected back by the target object within the field of view range and photons of ambient light within the field of view range.

When a single emitting channel emits a beam to the field of view space to a target object, a portion of the beam is reflected by the target object to the receiving panel to form a light spot. The energy of the light spot is mainly concentrated at the center of the light spot, and the energy of the light spot decreases from the center of the light spot to the surroundings. When the target object is a high-reflectivity object, the light spot expands on the receiving panel, causing the optical signal to overflow to other receiving channels. It can be understood that the beam emitted by the current emitting channel is not only received by the corresponding receiving channel but also received by other receiving channels, thereby generating optical crosstalk to other receiving channels. It can be understood that the emitting channel and the receiving channel have a one-to-one correspondence, that is, the beam emitted by the emitting channel can only be received by the corresponding receiving channel, otherwise, the beam emitted by the emitting channel generates optical crosstalk. The receiving channel corresponding to the emitting channel that emits light is called a working receiving channel.

The application scenario of the disclosure takes a target object as a high-reflectivity object and all emitting channels emit beams of the same band as an example.

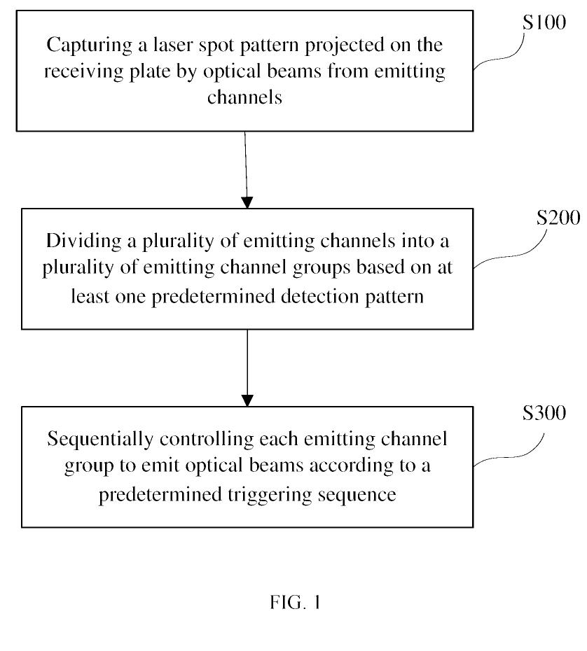

Referring to FIG. 1, FIG. 1 is a flowchart of a method for suppressing optical crosstalk in a multi-channel LiDAR in accordance with an embodiment. The specific execution steps of the method for suppressing optical crosstalk are as follows.

Step S100: capturing a laser spot pattern projected on the receiving plate by optical beams from emitting channels. Specifically, control different emitting channels to emit optical beams respectively, and determine the laser spot pattern formed on the receiving plate by the beam emitted by each emitting channel according to the light spot reflected by the target object to the receiving plate. A laser spot pattern with the largest crosstalk range is selected from the respective laser spot patterns corresponding to different emitting channels as the laser spot pattern template.

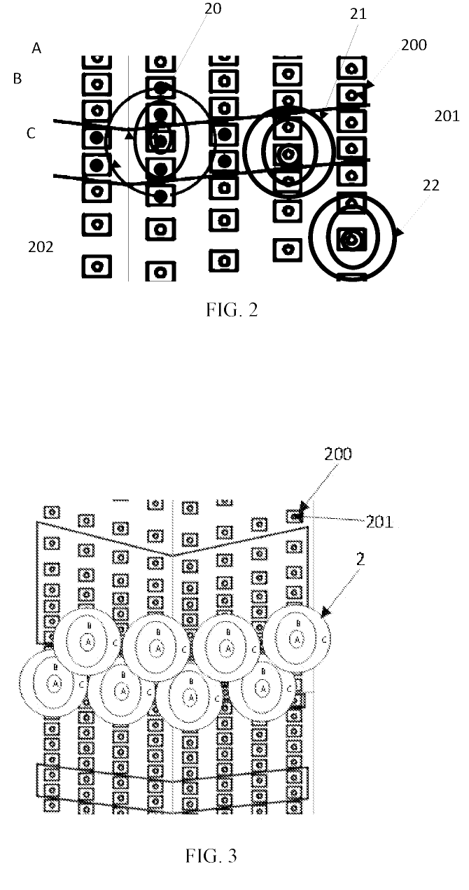

Referring to FIG. 2, in this embodiment, simulation is performed on the LiDAR based on the arrangement of the receiver 200 on the receiving plate, the photosensitive surface parameters of the receiver, and the model and design of the emitter 100. In the simulation system, a single emitting channel 101 on the emitting plate is controlled to emit a beam, the emitting beam propagates to the target object and becomes a receiving beam, and the target object reflects the receiving beam to the receiving plate. The receiving beam forms a light spot on the receiving plate, and the laser spot pattern formed by the light spot on the receiving plate is acquired. Corresponding laser spot patterns are acquired by simulating different emitting channels 101. A laser spot pattern with the largest crosstalk range is selected from the laser spot patterns as the final laser spot pattern, and the laser spot pattern is improved through simulation experiments to acquire the laser spot pattern template 2. Specifically, the receiver 200 covered by the laser spot pattern can be determined according to the area and shape of the laser spot pattern, thereby determining the interfered receiver 200. The combination of simulation and simulation experiments to acquire the laser spot pattern template improves the detection accuracy.

Referring to FIG. 2 again, in this embodiment, after simulating different emitting channels, the laser spot pattern 20, the laser spot pattern 21, and the laser spot pattern 22 are respectively obtained. The crosstalk ranges of the laser spot pattern 20, the laser spot pattern 21, and the laser spot pattern 22 are compared, and it is determined that the crosstalk range of the laser spot pattern 20 is the largest, so the laser spot pattern 20 is selected as the laser spot pattern template 2. The laser spot pattern template 2 is a circular pattern. The laser spot pattern template 2 is divided into region A, region B, and region C. Region A is the middle region of the light spot and is the region with the highest energy; region C is located in the outermost region of the light spot and is the region with the lowest energy; region B is the region between the outer boundary of region A and the inner boundary of region C and is the region with medium energy. The receiver 200 covered by region A is only the working receiving channel 202 corresponding to the emitting channel 101, and the receiver 200 covered by region B and region C is the interfered receiver 200. The shape of the laser spot pattern template 2, the range of crosstalk, and the region of the laser spot pattern corresponding to the working receiving channel 202 can be set according to actual conditions and are not limited herein. In some embodiments, the receiver covered by region A may also include both the working receiving channel 202 corresponding to the emitting channel 101 and multiple interfered receiving channels 201. The region corresponding to the current working receiving channel 202 in the laser spot pattern template 2 is identified from region A through multiple simulations.

Referring to FIG. 3, emitting channels 102 that emit optical beams in parallel are determined according to the overlap between multiple laser spot pattern templates 2 to acquire a predetermined detection pattern a formed by the emitting channels 102 that emit optical beams in parallel. Specifically, multiple emitting channels 101 emit optical beams in parallel to form corresponding laser spot pattern templates 2 on the receiving panel. If the overlapping portion between multiple laser spot pattern templates 2 does not include the receiving channel 201 corresponding to the current emitting channel 102, the pattern formed by the current emitting channels 102 that emit optical beams in parallel is set as the predetermined detection pattern a. It can be understood that emitting channels 101 corresponding to the receivers 200 covered by the overlapping portion of the laser spot pattern template 2 cannot emit optical beams simultaneously.

In this embodiment, emitting channels 102 that can emit optical beams in parallel are determined based on the arrangement of the receivers 200 on the receiving plate and the laser spot pattern template 2. Specifically, the working receiving channels 202 corresponding to the emitting channels 102 that emit optical beams in parallel do not interfere with each other, that is, the regions A of the laser spot pattern templates 2 corresponding to the emitting channels 102 that emit optical beams in parallel cannot overlap. A reference working receiving channel 202 is determined, and the position of the corresponding laser spot pattern template 2 is determined according to the reference working receiving channel 202. The interfered receiving channel 201 is confirmed according to the coverage of the current laser spot pattern template 2. The receiving channel 201 and the working receiving channel 202 in the range of the laser spot pattern template 2 of other receiving channels 201 are excluded to acquire alternative working receiving channels. The receiving channel 201 closest to the current laser spot pattern template 2 is selected from the alternative working receiving channels as the working receiving channel 202. This process is repeated until the receiving plate only has receiving channels that interfere with at least one working receiving channel 202 in all working receiving channels 202. All emitting channels 101 corresponding to the working receiving channels 202 are selected as emitting channels 102 that emit optical beams, and the pattern formed by the emitting channels 102 that emit optical beams is taken as the predetermined detection pattern a.

In some embodiments, if the receivers 200 are regularly arranged on the receiving plate. The arrangement rule of the receivers 200 on the receiving plate is divided into multiple small receiving blocks, and the corresponding emitting channels 101 are grouped according to the laser spot pattern template 2 for one receiving block. The detection pattern corresponding to the current receiving block is acquired, and the emitting channels 101 are grouped according to the detection pattern according to the arrangement rule of the receivers, and the detection patterns of each block jointly form the predetermined detection pattern.

Step S200:dividing a plurality of emitting channels into a plurality of emitting channel groups based on at least one predetermined detection pattern. Specifically, all emitters on the emitting plate are grouped according to the predetermined detection pattern a. Each emitting channel group includes emitting channels 101 that generate non-interfering light spots.

Referring to FIG. 4, in the first embodiment, the predetermined detection pattern a is a pattern formed by emitting channels 101 marked with black dots in the channel. The multiple emitting channels 101 corresponding to the current predetermined detection pattern a are taken as one group of emitting channel groups. The current predetermined detection pattern a is taken as a benchmark and shifted left or right several times to obtain multiple emitting channel groups until all emitting channels 101 in the row where the current detection pattern a is located emit optical beams once. The predetermined detection pattern a is shifted downward by one emitting channel 101 from the current predetermined detection pattern a position to obtain a new emitting channel group. That is, the predetermined detection pattern a is shifted downward by one emitting channel 101 to obtain the predetermined detection pattern a1. The predetermined detection pattern a1 is shifted left or right several times to obtain the multiple emitting channel groups until all emitting channels in the row where the current detection pattern a is located emit optical beams once. This process is repeated until all emitting channels 101 on the emitting plate emit optical beams once. It can be understood that each shift of the predetermined detection pattern a corresponds to one emitting channel group, and the number of shifts of the predetermined detection pattern a corresponds to the number of emitting channel groups.

In some embodiments, emitting channels 101 are grouped according to multiple predetermined detection patterns a according to predetermined grouping rules.

Step S300:sequentially controlling each emitting channel group to emit optical beams according to a predetermined triggering sequence. Specifically, control one group of channels in multiple groups of channels to emit optical beams according to the predetermined triggering sequence, and control other groups of channels to stop emitting optical beams. Whether the current group of channels finishes emitting optical beams is judged according to the emission period of the emitting channel. When it is detected that the current group of channels finishes emitting optical beams, the current group of channels is turned off, and the next group of channels is controlled to emit optical beams according to the triggering sequence. This process is repeated until the last channel group in the predetermined triggering sequence finishes emitting optical beams, the current round of multi-channel LiDAR detection is terminated, and the next round of multi-channel LiDAR detection is started, and the principle and sequence of the next round of detection are consistent with those of the current round. The control of each emitting channel group to emit optical beams is the control of the emitting channels included in each channel group to emit optical beams in parallel.

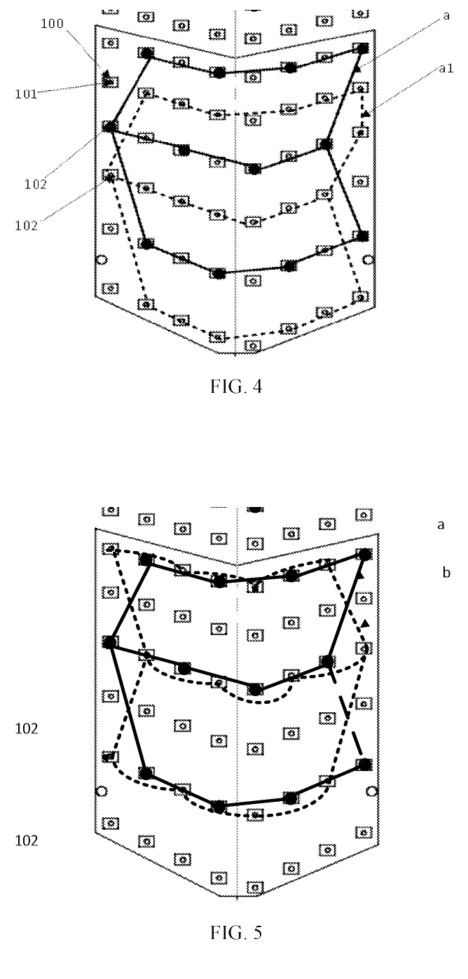

Referring to FIG. 5, FIG. 5 is a schematic diagram of a method for grouping emitting channel groups provided by a second embodiment. The difference between the method for grouping emitting channel groups provided by the second embodiment and the method for grouping emitting channel groups provided by the first embodiment lies in that emitting channels are grouped according to different predetermined detection patterns. In this embodiment, emitting channels are alternately grouped according to the predetermined detection pattern a and the predetermined detection pattern b.

It can be understood that the laser spot patterns and predetermined detection patterns in the above embodiments are merely examples. Herein, the scope and shape of channel crosstalk coverage are not limited. The control sequence is adapted according to the actually selected electronic components. At the same time, the total number of channels and the minimum number of channels that need to be controlled simultaneously are not limited and can be any number.

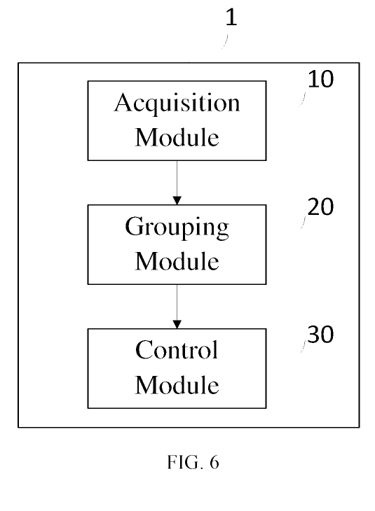

Referring to FIG. 6, the device 1 for suppressing optical crosstalk in a multi-channel LiDAR provided by the second aspect of the disclosure. The structure of the multi-channel LiDAR has been described above and will not be repeated herein. The device 1 includes an acquisition module 10, a grouping module 20, and a control module 30.

The acquisition module 10 is configured to acquire a laser spot pattern formed on the receiving plate by a beam emitted by the emitting channel. Specifically, control different emitting channels to emit optical beams respectively, and determine the laser spot pattern formed on the receiving plate by the beam emitted by each emitting channel according to the light spot reflected by the target object to the receiving plate. A laser spot pattern with the largest crosstalk range is selected from the respective laser spot patterns corresponding to different emitting channels as the laser spot pattern template.

The laser spot pattern is used to determine emitting channels that emit optical beams in parallel based on the overlap between multiple laser spot patterns, to obtain a predetermined detection pattern formed by the emitting channels that emit optical beams in parallel; wherein the overlap is an overlapping portion between multiple laser spot patterns, and the overlapping portion does not include a portion of the receiving channel corresponding to the currently emitting emitting channel.

The grouping module 20 is configured to divide multiple emitting channels into multiple emitting channel groups based on at least one predetermined detection pattern. Specifically, all emitters on the emitting plate are grouped according to the predetermined detection pattern a. Each emitting channel group includes emitting channels 101 that generate non-interfering light spots.

The control module 30 is configured to sequentially control each emitting channel group to emit optical beams according to a predetermined triggering sequence. Specifically, control one group of channels in multiple groups of channels to emit optical beams according to the predetermined triggering sequence, and control other groups of channels to stop emitting optical beams. Whether the current group of channels finishes emitting optical beams is judged according to the emission period of the emitting channel. When it is detected that the current group of channels finishes emitting optical beams, the current group of channels is turned off, and the next group of channels is controlled to emit optical beams according to the triggering sequence. This process is repeated until the last channel group in the predetermined triggering sequence finishes emitting optical beams, the current round of multi-channel LiDAR detection is terminated, and the next round of multi-channel LiDAR detection is started, and the principle and sequence of the next round of detection are consistent with those of the current round. The control of each emitting channel group to emit optical beams is the control of the emitting channels included in each channel group to emit optical beams in parallel.

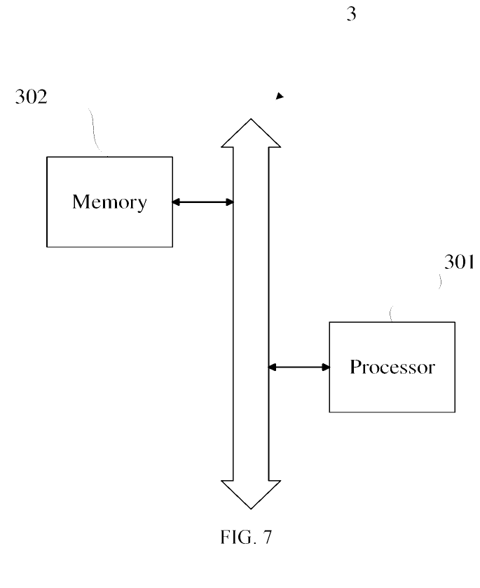

Referring to FIG. 7, the LiDAR 3 provided by the third aspect of the disclosure includes a memory 302 and a processor 301. The memory 302 is configured to store control program instructions for suppressing optical crosstalk in a multi-channel LiDAR, and the processor 301 is configured to execute the control instructions of the multi-channel LiDAR to implement The method.

The memory 302 includes at least one type of readable storage medium, which includes a flash memory, a hard disk, a multimedia card, a card-type memory (such as an SD or DX memory, etc.), a magnetic memory, a magnetic disk, an optical disk, etc. The memory 302 may be an internal storage unit of a computer device, such as a hard disk of the computer device, in some embodiments. In other embodiments, the memory 302 may also be a storage device of an external computer device, such as a plug-in hard disk equipped on the computer device, a Smart Media Card (SMC), a Secure Digital (SD) card, a Flash Card, etc. Furthermore, the memory 302 may also include both the internal storage unit of the computer device and the external storage device. The memory 302 may be used not only for storing application software and various types of data installed on the computer device, such as code for implementing lifting intelligent processing, but also for temporarily storing data that has been output or will be output.

The processor 301 may be a Central Processing Unit (CPU), a microcontroller, a microprocessor, or other data processing chips in some embodiments, and is configured to running the control program instructions of the LiDAR 3 stored in the memory 302.

In the above embodiments, all or part of the functions may be implemented in software, hardware, firmware, or any combination thereof. When implemented in software, all or part of the functions may be implemented in the form of a computer program product.

The computer program product includes one or more computer instructions. When the computer instructions are loaded and executed on a computer, all or part of the processes or functions according to the embodiments of the disclosure are generated. The computer device may be a general-purpose computer, a special-purpose computer, a computer network, or other programmable devices. The computer instructions may be stored in a computer-readable storage medium, or transmitted from one computer-readable storage medium to another computer-readable storage medium. For example, the computer instructions may be transmitted from one website, computer, server, or data center to another website, computer, server, or data center in a wired (such as coaxial cable, optical fiber, digital subscriber line (DSL)) or wireless (such as infrared, wireless, microwave, etc.) manner. The computer-readable storage medium may be any available medium that can be stored by a computer or include an integrated server, data center, and other data storage devices that include one or more available media. The available medium may be a magnetic medium (such as a floppy disk, a hard disk, a magnetic tape), an optical medium (such as a DVD), or a semiconductor medium (such as a Solid State Disk (SSD)), etc.

Those skilled in the art may clearly understand that, for the convenience and conciseness of description, the specific working processes of the system, devices, and units described above may refer to the corresponding processes in the method embodiment, and will not be repeated herein.

In the multiple embodiments provided by the disclosure, it should be understood that the disclosed systems, devices, and methods may be implemented in other ways. For example, the above-described device embodiment is merely schematic. For example, the division of units is merely a logical function division, and there may be other division methods during actual implementation. For example, multiple units or components may be combined or integrated into another system, or some features may be omitted or not performed. In another aspect, the coupling or direct coupling or communication connection shown or discussed may be an indirect coupling or communication connection through some interfaces, devices, or units, and may be in electrical, mechanical, or other forms.

The units described as separate components may or may not be physically separated, and the units displayed as units may or may not be physical units, that is, may be located in one place or may be distributed on a plurality of network units. A part or all of the units may be selected according to actual needs to achieve the purpose of the solution of the embodiment.

In addition, in various embodiments of the disclosure, the functional units may be integrated into one processing unit, or each unit may exist alone, or two or more units may be integrated into one unit. The integrated unit may be implemented in the form of hardware or in the form of a software functional unit.

If the integrated unit is implemented in the form of a software functional unit and sold or used as an independent product, it may be stored in a computer-readable storage medium. Based on such understanding, the technical solution of the disclosure, in essence, or the part contributing to the prior art, or all or part of the technical solution may be embodied in the form of a software product. The computer software product is stored in a storage medium and includes multiple instructions for enabling a computer device (which may be a personal computer, a server, or a network device, etc.) to execute all or part of the steps of the method according to the embodiments of the disclosure. The storage medium includes a U disk, a mobile hard disk, a Read-Only Memory (ROM), a Random Access Memory (RAM), a magnetic disk, or an optical disk, etc., which may store program code.

It should be noted that the serial numbers of the embodiments of the disclosure are merely for description and do not represent the superiority or inferiority of the embodiments. And the terms "comprises", "includes", or any other variants thereof in the disclosure are intended to cover non-exclusive inclusion. Thus, a process, method, article, or device that includes a series of elements not only includes those elements that are clearly listed, but also includes other elements that are not clearly listed or are inherent to such a process, method, article, or device. Elements limited by the phrase "comprising a..." do not exclude the presence of other identical elements in a process, method, article, or device that includes the element.

Obviously, those skilled in the art can make various modifications and variations to the disclosure without departing from the spirit and scope of the disclosure. In this way, if these modifications and variations of the disclosure fall within the scope of the claims of the disclosure and their equivalent technologies, the disclosure also intends to include these modifications and variations.

The above are only preferred embodiments of the disclosure, and the protection scope of the disclosure is not limited thereby. Any equivalent structure or equivalent process transformation made using the content of the specification and drawings of the disclosure, or directly or indirectly applied in other related technical fields, is also included in the protection scope of the disclosure.

1. A method for suppressing optical crosstalk in a multi-channel LiDAR, the multi-channel LiDAR comprising an emitting plate, and a receiving plate; the emitting plate being arranged with a plurality of emitters, and the receiving plate being arranged with a plurality of receivers, each emitter comprising a corresponding emitting channel, and each receiver comprising a corresponding receiving channel, the method comprising:
capturing a laser spot pattern projected on the receiving plate by optical beams from emitting channels; wherein the laser spot pattern determines concurrently active emitting channels through inter-pattern overlap analysis, generating a predetermined detection pattern, the overlap degree represents non-interfering regions among multiple laser spot patterns, excluding receiving channels aligned with currently active emitters;
dividing a plurality of emitting channels into a plurality of emitting channel groups based on at least one predetermined detection pattern; and
sequentially controlling each emitting channel group to emit optical beams according to a predetermined triggering sequence.

2. The method according to claim 1, wherein emitters corresponding to each emitting channel group are simultaneously driven to emit optical beams.

3. The method according to claim 1, wherein sequentially controlling each emitting channel group to emit optical beams according to a predetermined triggering sequence is implemented by:
when a current emitting channel group finishes emitting optical beams, the predetermined triggering sequence controls a next emitting channel group to emit optical beams.

4. The method according to claim 3, wherein when all emitting channel groups finish emitting optical beams, a current emission round is ended, and a new emission round is started.

5. The method according to claim 1, wherein the arrangement of the emitters on the emitting plate corresponds to the arrangement of receivers on the receiving plate.

6. The method according to claim 1, wherein the overlap between multiple laser spot patterns is a portion of the receiving channel interfered by the spot, and the emitting channel corresponding to the interfered receiving channel is turned off.

7. The method according to claim 6, wherein the laser spot pattern includes areas and shapes of the spots covering the receiving plate.

8. The method according to claim 6, wherein the laser spots from different emitting channels produce equivalent crosstalk in corresponding receiving channels.

9. A LiDAR, comprising:
a memory, configured to store program instructions; and
a processor, configured to execute the program instructions to perform a method for suppressing optical crosstalk in a multi-channel LiDAR, the method comprising:
capturing a laser spot pattern projected on the receiving plate by optical beams from emitting channels; wherein the laser spot pattern determines concurrently active emitting channels through inter-pattern overlap analysis, generating a predetermined detection pattern, the overlap degree represents non-interfering regions among multiple laser spot patterns, excluding receiving channels aligned with currently active emitters;
dividing a plurality of emitting channels into a plurality of emitting channel groups based on at least one predetermined detection pattern; and
sequentially controlling each emitting channel group to emit optical beams according to a predetermined triggering sequence.

10. The LiDAR according to claim 9, wherein emitters corresponding to each emitting channel group are simultaneously driven to emit optical beams.

11. The LiDAR according to claim 9, wherein sequentially controlling each emitting channel group to emit optical beams according to a predetermined triggering sequence is implemented by:
when a current emitting channel group finishes emitting optical beams, the predetermined triggering sequence controls a next emitting channel group to emit optical beams.

12. The LiDAR according to claim 11, wherein when all emitting channel groups finish emitting optical beams, a current emission round is ended, and a new emission round is started.

13. The LiDAR according to claim 9, wherein the arrangement of the emitters on the emitting plate corresponds to the arrangement of receivers on the receiving plate.

14. The LiDAR according to claim 9, wherein the overlap between multiple laser spot patterns is a portion of the receiving channel interfered by the spot, and the emitting channel corresponding to the interfered receiving channel is turned off.

15. The LiDAR according to claim 14, wherein the laser spot pattern includes areas and shapes of the spots covering the receiving plate.

16. The LiDAR according to claim 15, wherein the laser spots from different emitting channels produce equivalent crosstalk in corresponding receiving channels.

17. A method for suppressing optical crosstalk in a multi-channel LiDAR, comprising:
capturing a laser spot pattern projected on a receiving plate by optical beams from emitting channels of the multi-channel LiDAR; wherein the laser spot pattern determines concurrently active emitting channels through an overlap degree, generating a predetermined detection pattern, wherein the overlap degree represents non-interfering regions among multiple laser spot patterns, excluding receiving channels aligned with currently active emitters;
dividing a plurality of emitting channels of the multi-channel LiDAR into a plurality of emitting channel groups based on at least one predetermined detection pattern; and
sequentially controlling each emitting channel group to emit optical beams according to a predetermined triggering sequence.

18. The method according to claim 17, wherein emitters corresponding to each emitting channel group are simultaneously driven to emit optical beams.

19. The method according to claim 17, wherein sequentially controlling each emitting channel group to emit optical beams according to a predetermined triggering sequence is implemented by:
when a current emitting channel group finishes emitting optical beams, the predetermined triggering sequence controls a next emitting channel group to emit optical beams.

20. The method according to claim 19, wherein when all emitting channel groups finish emitting optical beams, a current emission round is ended, and a new emission round is started.
